(19) United States
(12) Patent Application Publication
(10) Pub. No.: US 2025/0385324 A1
(43) Pub. Date: Dec. 18, 2025

(54) RECONFIGURABLE BATTERY ENERGY STORAGE SYSTEM (BESS) AC WIRING

(71) Applicant: Enphase Energy, Inc., Petaluma, CA (US)

(72) Inventors: Jonathan List EHLMANN, Austin, TX (US); Ocie Carignan WARD, Petaluma, CA (US); Chris Morrow YOUNG, Round Rock, TX (US); David Garrett STANTON, Austin, TX (US); Brian ACKER, Sebastopol, CA (US); Christiaan Johannes VAN ANTWERPEN, Mountain View, CA (US)

(21) Appl. No.: 19/213,346

(22) Filed: May 20, 2025

Related U.S. Application Data
(60) Provisional application No. 63/661,341, filed on Jun. 18, 2024.

(51) Int. Cl. H01M 10/42; H01M 50/502; H02J 3/32; H02J 3/38

(52) U.S. Cl. CPC H01M 10/425; H01M 50/502; H02J 3/32; H02J 3/381; H02J 2310/12

(57) ABSTRACT

A battery energy storage system is provided and comprises a battery module comprising a plurality of batteries and a plurality of microinverters including wiring that is grouped in a branch cable that connects to a trunk cable for connecting the wiring to a wiring box.

### CROSS-REFERENCE TO RELATED APPLICATIONS

The present application claims the benefit of and priority to U.S. Provisional Application Ser. No. 63/661,341, filed on Jun. 18, 2024, the entire contents of which is incorporated herein by reference.

### BACKGROUND

### 1. Field of the Disclosure

Embodiments of the present disclosure generally relate to a BESS and, for example, to reconfigurable BESS AC wiring.

### 2. Description of the Related Art

Conventional power conversion systems are known and can include a BESS that can be configured to capture the energy from different sources and store the energy in one or more rechargeable batteries for later use. The BESS is often combined with renewable energy sources to accumulate the renewable energy during an off-peak time, so that the energy can be used when needed at peak time. In most instances, string inverters can be made in different SKUs for single, split, and three-phase and used across multiple applications. For example, in some instances single-phase inverters can be combined with a neutral-forming transformer for three-phase systems. Likewise, in some instances, single-phase inverters can be combined together to form three-phase grids.

Additionally, BESSs can be used worldwide with many different grid configurations. For example, in North America, the gird configurations can be 120/240 Split-Phase, 120/208 Two-phase, and 120/208Y Three-Phase. In the rest of the World (RoW), the gird configurations can be 230V Single-Phase or 230/400Y Three-Phase. Without a way to reconfigure the BESS system, however, companies need to develop and service multiple stock keeping units (SKUs) of BESS or BESS sub-systems.

Therefore, described herein is improved reconfigurable BESS AC wiring.

### SUMMARY

In accordance with some aspects of the present disclosure, a battery energy storage system comprises a battery module comprising a plurality of batteries and a plurality of microinverters including wiring that is grouped in a branch cable that connects to a trunk cable for connecting the wiring to a wiring box.

In accordance with some aspects of the present disclosure, a battery energy storage system comprises a battery module comprising a plurality of stacked batteries and a plurality of microinverters including wiring that is grouped in a branch cable that connects to a trunk cable connected to at least one of a top or bottom of a wiring box for connecting the wiring to the wiring box.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a diagram of a BESS configured for use with the system for power conversion of FIG. 1, in accordance with at least some embodiments of the present disclosure;

FIG. 3 is a diagram of a column of batteries, inverters, and wiring of the BESS of FIG. 2, in accordance with at least some embodiments of the present disclosure;

FIG. 4 is a wiring diagram of the BESS of FIG. 2, in accordance with at least some embodiments of the present disclosure;

FIG. 5 is a wiring diagram of the BESS of FIG. 2, in accordance with at least some embodiments of the present disclosure;

FIG. 6 is a wiring diagram of the BESS of FIG. 2, in accordance with at least some embodiments of the present disclosure;

FIG. 7 is a wiring diagram of the BESS of FIG. 2, in accordance with at least some embodiments of the present disclosure;

FIG. 8 is a wiring diagram of the BESS of FIG. 2, in accordance with at least some embodiments of the present disclosure; and

FIG. 9 illustrates diagrams of a terminal connections of the BESS of FIG. 2, in accordance with at least some embodiments of the present disclosure.

### DETAILED DESCRIPTION

In accordance with the present disclosure, described herein is improved reconfigurable BESS AC wiring. For example, a battery energy storage system (BESS) can comprise a battery module comprising a plurality of batteries and a plurality of microinverters including wiring that is grouped in a branch cable that connects to a trunk cable for connecting the wiring to a wiring box. The BESSs described herein allow for AC wiring reconfigurability inside a wiring box while in the field. Additionally, unlike conventional BESSs, the BESSs described herein minimize the amount of service multiple stock keeping units (SKUs) of BESSs or BESS sub-systems that companies need to develop.

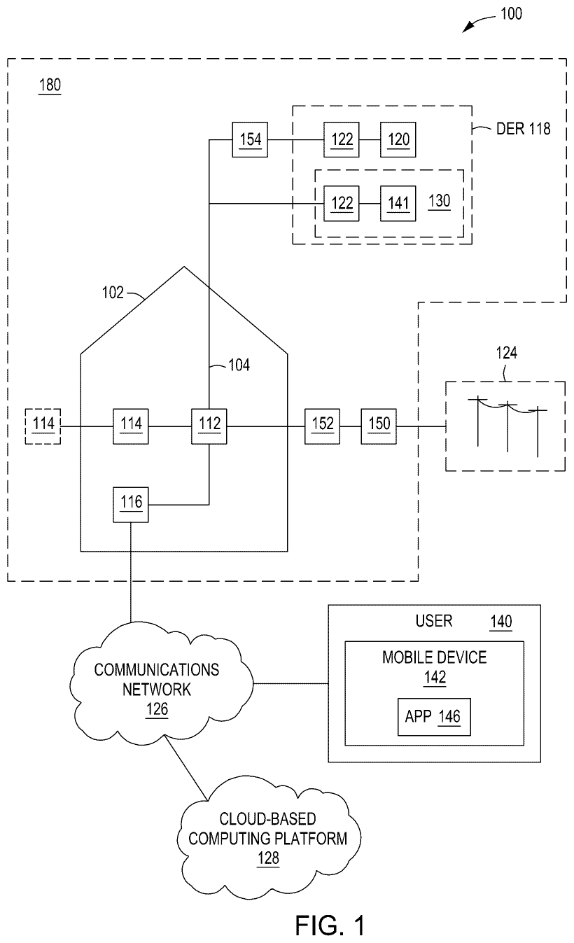

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. Alternatively, the DER 118 can be situated inside the structure 102. For example, when the DER 118 is a permanent residential battery energy storage system, the DER 118 may be installed in a garage (or other suitable location inside the structure 102). The structure 102 comprises one or more loads 114 (and/or energy storage devices), e.g., portable energy systems (PES), appliances, electric hot water heaters, thermostats/detectors, boilers, electric vehicle supply equipment (EVSE), EVs, water pumps, and the like, which can be located within or outside the structure 102, and a DER controller 116, each coupled to a load center 112. Although the one or more loads 114 (and/or energy storage devices), the DER controller 116, and the load center 112 are depicted as being located within the structure 102, one or more of these may be located external to the structure 102.

The load center 112 is coupled to the DER 118 by an AC bus 104 and is further coupled, via a meter 152 (utility meter comprising a utility meter socket) and optionally a MID 150 (microgrid interconnect device), to a grid 124 (e.g., a commercial/utility power grid). The structure 102, the one or more loads 114 (and/or energy storage devices), DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122 (e.g., microinverter, power converter, power conversion units (PCUs), etc.). For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a DC battery 141 may be referred to as an AC battery 130.

The power conditioners 122 invert the generated DC power from the plurality of RESs 120 and/or the DC battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the one or more loads 114 (and/or energy storage devices). In addition, the power conditioners 122 that are coupled to the DC batteries convert AC power from the AC bus 104 to DC power for charging the DC batteries. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein (e.g., the methods described herein).

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (KVAR). The generation meter 154 may communicate the measured values to the DER controller 116, for example using PLC, other types of wired communications, or wireless communication. Additionally, battery charge/discharge values are received through other networking protocols from the DC battery itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (KVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a relay, a contactor, or the like) for physically connecting/disconnecting the microgrid 180 to/from the grid 124. For example, the DER controller 116 receives information regarding the present state of the system from the power conditioners 122 and also receives the energy consumption values of the microgrid 180 from the meter 152 (e.g., via one or more of PLC, other types of wired communication, and wireless communication), and based on the received information (inputs), the DER controller 116 determines when to go on-grid or off-grid and instructs the MID 150 accordingly. In some embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The mobile device 142 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be managed differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

As noted above, improved reconfigurable BESS AC wiring are provided herein to allow for AC wiring reconfigurability inside a wiring box while in the field and to minimize the amount of service multiple stock keeping units (SKUs) of BESSs or BESS sub-systems that companies need to develop.

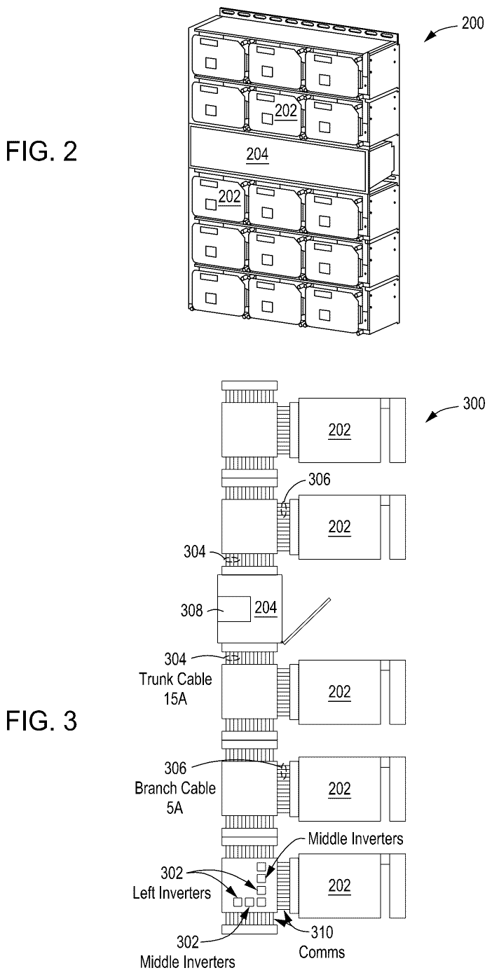

For example, FIG. 2 is a diagram of a BESS 200 configured for use with the system 100 for power conversion of FIG. 1, and FIG. 3 is a diagram 300 of a column of batteries, inverters, and wiring of the BESS 200 of FIG. 2, in accordance with at least some embodiments of the present disclosure. The BESS 200 can comprise one or more batteries 202 (battery modules). The one or more batteries 202 can be stacked upon each other and connected to each other in any conventional manner. In the illustrated embodiment, the one or more batteries 202 are stacked/connected to each other in a matrix of three columns and five rows. Between one or more of the columns and/or rows is a wiring box 204 (e.g., a common wiring box). In the illustrated embodiment, one wiring box 204 is connected between two columns and two rows of batteries (top batteries) and three rows and three columns of batteries (bottom batteries). The wiring box 204 allows a user (e.g., a technician) to connect one or more microinverter wires to a terminal block located inside the wiring box 204.

For example, as illustrated in FIG. 3, each of the one or more batteries 202 can comprise one or more microinverters 302. In the illustrated embodiment, the one or more batteries 202 comprises three microinverters, e.g., a left microinverter, a middle microinverter, and a right microinverter). The one or more microinverters 302 can be packaged in a single package (as in the illustrated embodiment). Alternatively, the one or more microinverters 302 can be individually packaged separately, integrated in the same package, and/or derived from circuitry that provides the one/two/three phases. Instead of combining a microinverter's wiring inside the battery module 200 (as is conventionally done), the microinverter's wiring can be attached to a trunk cable 304 and a branch cable 306. For example, in the trunk cable 304, three sets of microinverters can be attached in parallel. Thus, allowing left microinverter groups, middle microinverter groups, and right microinverter groups to be reconfigured in the wiring box 204, which can accommodate BESSs of various sizes. In at least some embodiments, the BESS 200 can be a 20 kWh unit that requires 75 A capacity, e.g., for connecting to building wiring. In such embodiments, two trunk cables can enter/connect to the wiring box 204, e.g., a trunk cable 304 from the top of the wiring box 204 and a trunk cable 304 from the bottom of the wiring box 204, as illustrated in FIG. 3. Additionally, in such embodiments the trunk cable 304 can have 15 A capacity, and the branch cable 306 can have 5 A capacity. Additionally, one or more communication wires 310 (phase-locked loop (PLL), measurement-only, etc.) may also be provided in the trunk cable 304 and the branch cable 306.

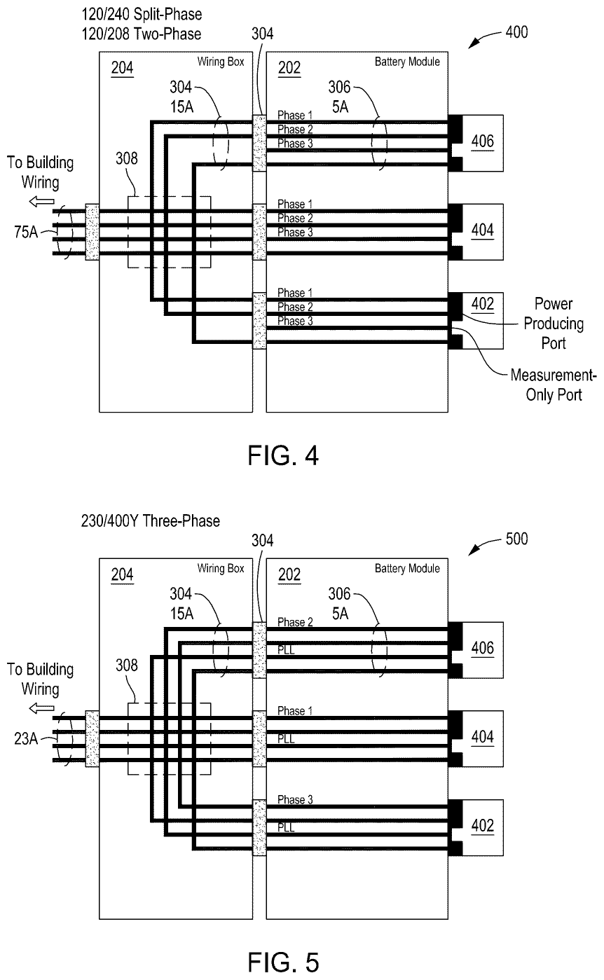

FIG. 4 is a wiring diagram 400 of the BESS of FIG. 2, in accordance with at least some embodiments of the present disclosure. For example, a left microinverter 402, a middle microinverter 404, and a right microinverter 406 (bottom, middle, top, respectively) of each battery module are attached in parallel and enter via the trunk cable 304 the wiring box 204. The left microinverter 402, the middle microinverter 404, and the right microinverter 406 can enter from above and/or below the wiring box 204. Once in the wiring box 204, the left microinverter 402, the middle microinverter 404, and the right microinverter 406 are attached together in the wiring box 204 (e.g., via a terminal block 308, see FIGS. 3 and 4, for example). Thus, the three microinverter groups' phase 1s are attached together and the microinverter groups' phase 2 connections are attached together, e.g., for Split-Phase microinverters, and are used to control current on both Phase 1 and Phase 2, and Phase 3 measurement-only port can be left unattached.

FIG. 5 is a wiring diagram 500 of the BESS of FIG. 2, in accordance with at least some embodiments of the present disclosure. For example, for 230/400Y, the three microinverter groups' can be rearranged. For example, to balance the phases, the middle microinverter group is attached to phase 1, the top microinverter group is attached to phase 2, and the bottom microinverter group is attached to phase 3. The microinverter groups are attached such that each group has the same three-phase rotation. In at least some embodiments, measurement-only ports can be attached to enable the three-phase PLL.

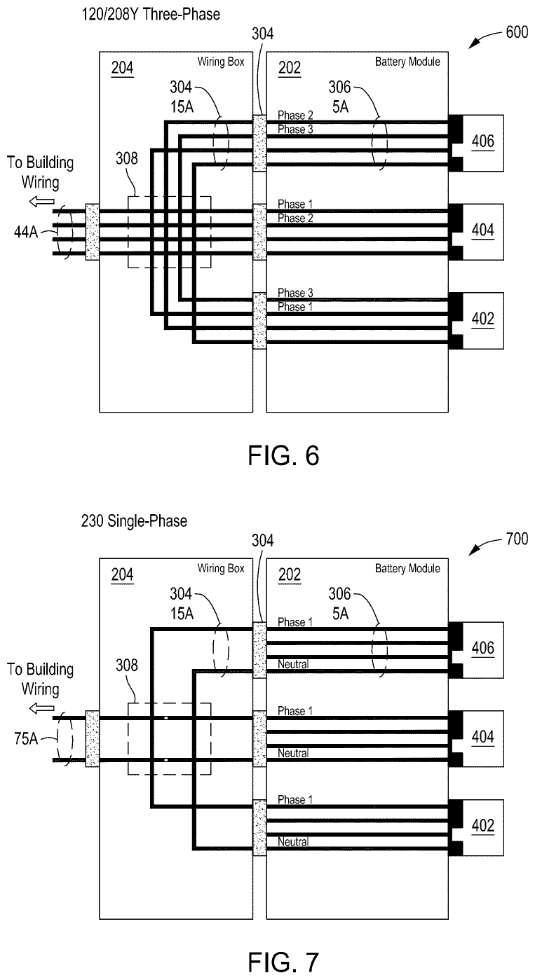

FIG. 6 is a wiring diagram 600 of the BESS of FIG. 2, in accordance with at least some embodiments of the present disclosure. For example, for 120/208Y, the three microinverter groups' can be rearranged. For example, to balance the phases, the middle microinverter group is attached to phase 1 and phase 2, the top microinverter group is attached to phase 2 and phase 3, and the bottom microinverter group is attached to phase 3 and to phase 1. The microinverter groups are attached such that each group has the same three-phase rotation, are configured for Split-Phase microinverters, and are used to control neutral current and operate efficiently with a L-L voltage of 208V.

FIG. 7 is a wiring diagram 700 of the BESS of FIG. 2, in accordance with at least some embodiments of the present disclosure. For example, Single-Phase inverters can be used for a cost reduction (e.g., one less AC GaN bridge). In such embodiments, Phase 1 and Neutral are attached in the wiring box 204, and the measurement only Phase 2 and Phase 3 connection can be left disconnected.

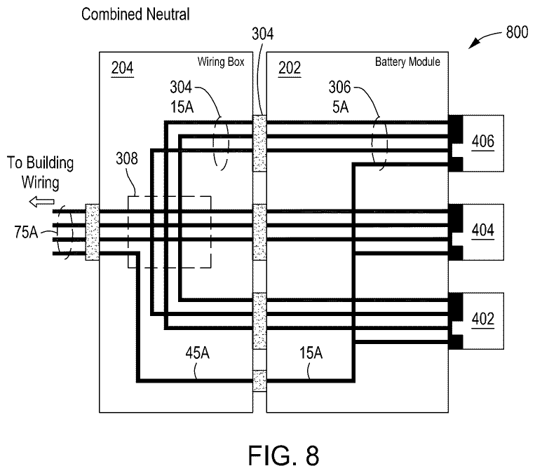

FIG. 8 is a wiring diagram 800 of the BESS of FIG. 2, in accordance with at least some embodiments of the present disclosure. For example, a single, larger neutral conductor 802 can be run between the one or more batteries 202, which can provide lower manufacturing cost of the BESS.

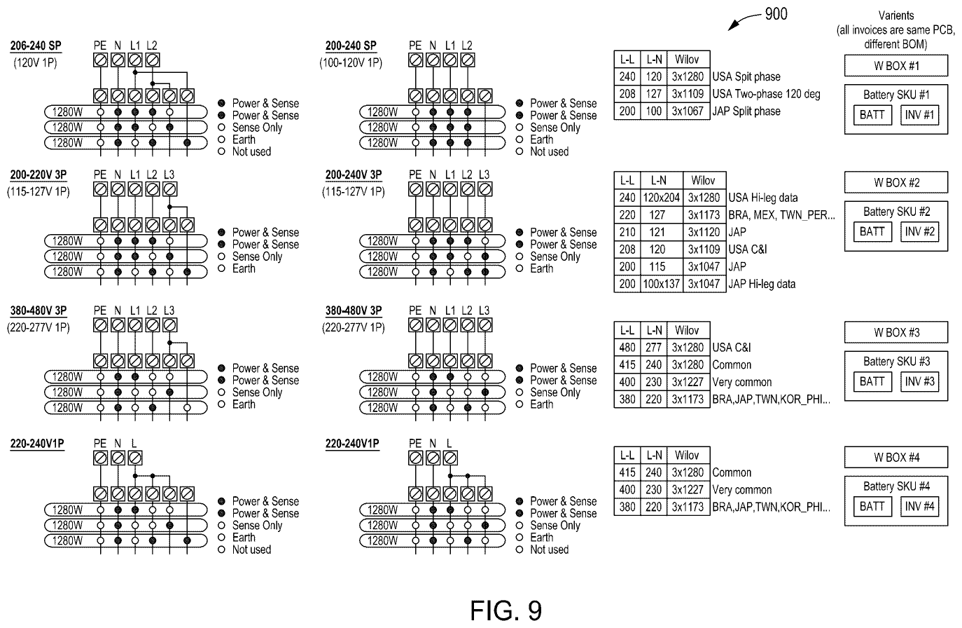

FIG. 9 illustrates diagrams 900 of terminal connections of the BESS of FIG. 2, in accordance with at least some embodiments of the present disclosure.

While the foregoing is directed to embodiments of the present disclosure, other and further embodiments of the disclosure may be devised without departing from the basic scope thereof, and the scope thereof is determined by the claims that follow.

1. A battery energy storage system, comprising:
a battery module comprising a plurality of batteries and a plurality of microinverters including wiring that is grouped in a branch cable that connects to a trunk cable for connecting the wiring to a wiring box.

2. The battery energy storage system of claim 1, wherein the branch cable has a 5 A capacity.

3. The battery energy storage system of claim 1, wherein the trunk cable has a 15 A capacity.

4. The battery energy storage system of claim 1, wherein the battery energy storage system has a 20 kWh rating and a 75 A capacity.

5. The battery energy storage system of claim 1, wherein the wiring connects to a terminal block disposed within the wiring box.

6. The battery energy storage system of claim 1, wherein the plurality of microinverters comprises a top microinverter, middle microinverter, and bottom microinverter that are connected in parallel.

7. The battery energy storage system of claim 6, wherein the top microinverter, middle microinverter, and bottom microinverter are configured for at least one of 120/240 split-phase or 120/208 two-phase operation.

8. The battery energy storage system of claim 6, wherein the top microinverter, middle microinverter, and bottom microinverter are configured for 230/400Y three-phase operation.

9. A battery energy storage system, comprising:
a battery module comprising a plurality of stacked batteries and a plurality of microinverters including wiring that is grouped in a branch cable that connects to a trunk cable connected to at least one of a top or bottom of a wiring box for connecting the wiring to the wiring box.

10. The battery energy storage system of claim 9, wherein the branch cable has a 5 A capacity.

11. The battery energy storage system of claim 9, wherein the trunk cable has a 15 A capacity.

12. The battery energy storage system of claim 9, wherein the battery energy storage system has a 20 kWh rating and a 75 A capacity.

13. The battery energy storage system of claim 9, wherein the wiring connects to a terminal block disposed within the wiring box.

14. The battery energy storage system of claim 9, wherein the plurality of microinverters comprises a top microinverter, middle microinverter, and bottom microinverter that are connected in parallel.

15. The battery energy storage system of claim 14, wherein the top microinverter, middle microinverter, and bottom microinverter are configured for at least one of 120/240 split-phase or 120/208 two-phase operation.

16. The battery energy storage system of claim 14, wherein the top microinverter, middle microinverter, and bottom microinverter are configured for 230/400Y three-phase operation.
